(19) United States
(12) Patent Application Publication
(10) Pub. No.: US 2020/0387837 A1
(43) Pub. Date: Dec. 10, 2020

(54) METHOD AND APPARATUS FOR PICKUP AND COORDINATION OF TRAVELLING USERS IN A TRANSPORTATION BOOKING SYSTEM

(71) Applicant: Monginis Foods Pvt Ltd, Mumbai (IN)

(72) Inventor: Qusai Zoher KHORAKIWALA, Mumbai (IN)

(21) Appl. No.: 16/432,975

(22) Filed: Jun. 6, 2019

(51) Int. Cl. G06Q 10/02; G06Q 50/30; G01C 21/34; G08G 1/00

(52) U.S. Cl. CPC G06Q 10/02; G08G 1/202; G01C 21/3438; G06Q 50/30

(57) ABSTRACT

The present invention provides a system, method and an apparatus for the pick-up coordination and verification for rides booked in a transportation booking system. The system comprises of a set of databases i.e. user database, vehicle database and a ride database; a set of modules i.e. a pickup coordination module, an identification detail module, a location module, a display module, a vehicle booking module, a ride sharing confirmation module and a maps module. With this invention, the user intending to travel can complete pick-up coordination and verification for rides booked in a transportation booking system.

### BACKGROUND OF THE INVENTION

The online transportation booking system prevailing includes members like travelling user, drivers and approved vehicles and travel booking service providers. The service providers register users and assign authentication credentials, similarly the driver's credentials are scrutinized and the vehicle evaluated for road worthiness before engaging the drivers and associated vehicles in the online transportation booking system. Online transportation booking systems,) enable authenticated users to select engaged vehicles based on geographical location of the travelling user and the engaged vehicles in real time based on user's choice of vehicle model/variant and time of intended journey. Recently, online transportation booking system providers enable authenticated users option of the live tracking of engaged vehicles.

However, online transportation booking systems, especially those offering online transportation booking through Radio Frequency (RF) based data communication applications may disable identification of a driver when a user intending to travel is close to it at a predefined and pre-coordinated pickup location for a predetermined time based on preset and preauthorized identification details visible to a travelling user from a distance of the driver's vehicle thus unable to board the booked vehicle in a crowded area within a short period of time, partly due to the fact that the current online transportation booking system and its computer-implemented method or computer implemented interface adaptations like transportation booking mobile applications do not have the ability to allow user intending to travel to preset identification details and preauthorize their electronic display on driver vehicles for a predetermined period of time during the proximity of the booked ride's associated vehicle to the user device of the user intending to travel.

Currently, the only means available to coordinate with a vehicle for transportation is either by calling, messaging the driver of the vehicle or by locating a vehicle, from a plurality of vehicles, by its vehicle number at the predefined pickup location, which is inconvenient, inefficient and a cause for distress and traffic in a crowded area.

U.S. Pat. No 20040260470A1 is directed towards improving coordinating pickup of users by providing an apparatus and method of reserving conveyance, such as, but not limited to taxis and limousines, in which the pickup locations, times, and contract are established and logged electronically. However, the invention does not provide an effective method or way to locate the user or for the user to locate the reserved vehicle in close proximity.

Further, the user is compelled s to contact the allocated driver of the reserved vehicle till the allocated driver or the reserved vehicle is located by the user or search the reserved vehicle using the vehicle number of the reserved vehicle mentioned at the front end and rear end of the reserved vehicle, not visible easily, as a means to identify a reserved vehicle from a plurality of similar appearance vehicles present at a pickup location.

A user is restricted from identifying a reserved vehicle that triggers identification when a user is close to it at a predefined and pre-coordinated pickup location for a predetermined time based on preset and pre-authorized identification details visible to a user intending to travel from a distance in a crowded area within a short period of time.

### SUMMARY OF THE INVENTION

The present invention specifically relates to pick-up coordination and verification of user intending to travel in an online transportation booking system.

Another aspect of the present invention relates to pre-authorizing display of identifications details pertaining to the user on an electronic display mounted on the reserved vehicle prior to booking with the online transportation system,

Another aspect of the invention is wherein the identification details at the time of the pick-up include the passenger's username, user Identification Details (ID), the last 4 digits of the user's mobile number, at least one user profile picture, the last 4 digits of the driver's mobile number, the driver's name, booked vehicle number or a unique identification code associated with the user or vehicle or ride and any phrase selected by the user.

Another aspect of the invention is wherein the predefined radius for pickup is a perimeter set by the transport system to determine the vehicles available for booking within the vicinity of the user.

Yet another aspect of the present invention is wherein the display of identification details further facilitates successive pickup of multiple users in a transportation system.

Other objects and advantages of the present invention will become apparent from the following description taken in conjunction with the accompanying drawings, wherein, by way of illustration and example, the aspects of the present invention are disclosed.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a functional block diagram of a transportation booking system 100 according to one embodiment.

FIG. 2 is a functional block diagram of a pickup coordination module 110 of FIG. 1 according to one embodiment.

FIG. 3 is a process flow diagram of the method for pick-up coordination and verification of user intending to travel in a transportation booking system according to one embodiment.

FIG. 4 illustrates modules of an example machine 400 able to read instructions from a machine-readable medium and execute them in a processor (or controller) according to one embodiment.

### DETAILED DESCRIPTION OF THE INVENTION

The following description describes various features and functions of the disclosed method and apparatus with reference to the accompanying figures. In the figures, similar symbols identify similar components, unless context dictates otherwise. The illustrative aspects described herein are not meant to be limiting.

These and other features and advantages of the present invention may be incorporated into certain embodiments of the invention and will become more fully apparent from the following description and claims or may be learned by the practice of the invention as set forth hereinafter. It may be readily understood that certain aspects of the disclosed system, method and apparatus can be arranged and combined in a wide variety of different configurations, all of which are contemplated herein.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a,” “an,” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof.

The Figures (FIGS.) and the following description relate to embodiments by way of illustration only. It should be noted that from the following discussion, alternative embodiments of the systems, methods, figures, diagrams and interfaces disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the systems, methods, figures, diagrams and interfaces illustrated herein may be employed without departing from the principles described herein. In the following description, for the purposes of explanation, numerous specific details are set forth in order to provide a thorough understanding of the various embodiments. It will be evident, however to one skilled in the art that the various embodiments may be practiced without these specific details.

### Configuration Overview

A system and method for pick-up coordination and verification of user intending to travel in a transportation booking system is provided. The pickup coordination module in the transportation booking system may comprise a plurality of modules and generators like a pickup coordination module 110, an identification detail module 202, a location module 204, a display module 206, a vehicle booking module 208, a ride sharing confirmation module 210 and a maps module 212. The method for pick-up coordination and verification of user intending to travel in a transportation booking system may comprise a plurality of steps like determining the location of the user intending to travel device associated with a ride and a driver user device, displaying a predefined identification detail on the corresponding vehicle electronic display board when the user intending to travel device is a predefined proximate distance from driver user device, determining dynamically the updated location of passenger user device after predetermined interval of time and switching off display of identification detail on the vehicle's electronic display board after preset conditions previously authorized by the user intending to travel.

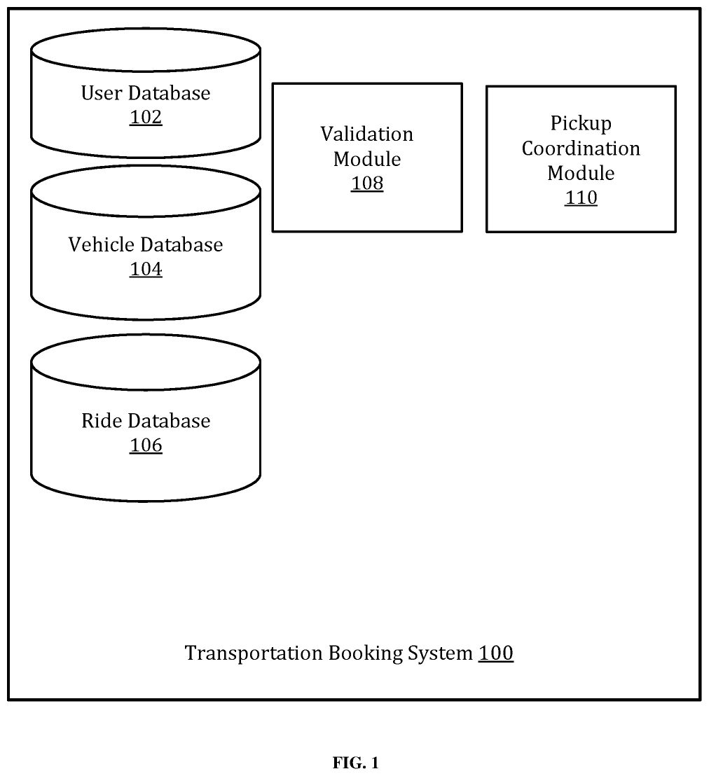

FIG. 1 is a block diagram of a transportation booking system 100 according to one embodiment. The transportation booking system 100 includes a plurality of databases and modules for pick-up coordination and verification of user intending to travel in the transportation booking system 100. The closed network group food item listings are made available to users using a pickup-coordination module 110. Additional modules of the transportation booking system 100 are described below.

A user database 102 may maintain information about each type of user based on the user's role in the system. The user information may be stored in a plurality of databases, each database associated with a user role, or the user roles may be stored in the user database 102. For example, the additional user roles may include user intending to travel, driving users, travel booking service providing users, and other types of users of the transportation booking system 100.

The user database 102 is further configured for receiving, storing, updating and retrieving a plurality of data fields of each user, such as, but not limited to user's name, address, and contact details. Depending on the user's role in the transportation booking system 100, the user database 102 maintains additional information of the user. For example, for an exemplary user intending to travel, the user database 102 maintains travel booking and ride history in the transportation booking system 100.

In one embodiment, a distinct vehicle database 104 is configured for receiving, storing, updating and retrieving a plurality of data fields of each vehicle and associated driver, comprising name of the driver, location history, booking history, driver ratings, preferences, surge pricing, per km/mile pricing, vehicle registration details, driver's license and registration, as well as other vehicle ride booking criteria.

In one embodiment, a distinct ride database 106 is configured for receiving, storing, updating and retrieving a plurality of data fields of each ride, comprising details of the driver, the user intending to travel, location tracking information of user intending to travel, pickup and drop-off points, landmarks, ride fees as well as other ride criteria.

A validation module 108 is configured for validating credentials of the exemplary user intending to travel of the transportation booking system 100.

A pickup coordination module 110 is configured for pick-up coordination and verification of user intending to travel in the transportation booking system 100. In another embodiments, prior to booking the ride, the user pre-authorizes display of identification details on an electronic display device associated with the vehicle. In yet another embodiments, the identification details at the time of the pick-up include passenger's username, user ID, last 4 digits of the user's mobile number, at least one user profile picture, last 4 digits of the driver's mobile number, driver's name, booked vehicle number or a unique identification code associated with the user or vehicle or ride and any phrase selected by the user. In other embodiments, the predefined radius for pickup is a perimeter set by the transport system to determine the vehicles available for booking within the vicinity of the user. In still other embodiments, the display of identification details further comprise the successive pickup of multiple users in a mobile transportation system.

In one embodiment, the user database 102, vehicle database 104, ride database 106, and other databases form a single consolidated database in the transportation booking system 100.

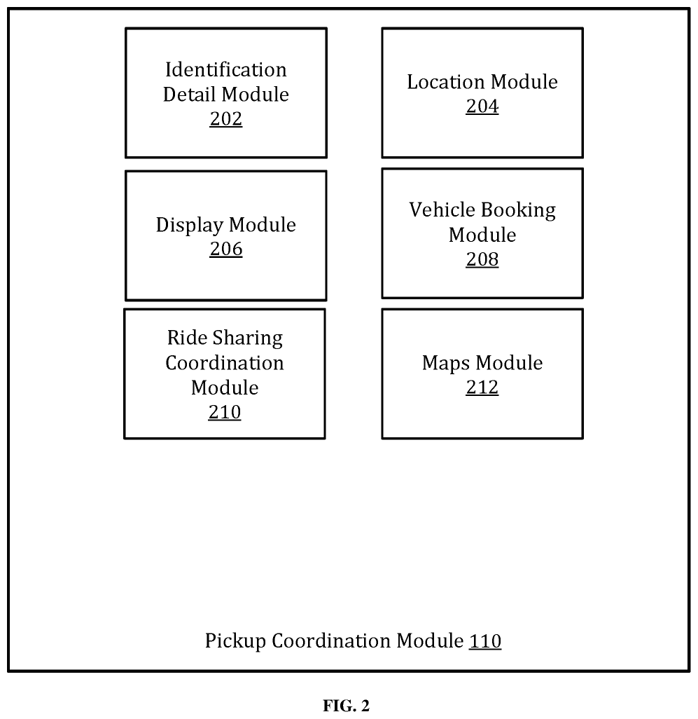

FIG. 2 is a block diagram of a pickup coordination module 110 according to one embodiment. The pickup coordination module 110 is configured for receiving, storing, retrieving and updating a plurality of pickup and coordination based ride items in a transportation booking system 100. In some embodiments, the pickup and coordination based ride items may be accessed from a ride database 106.

The identification detail module 202 is configured for receiving, storing, retrieving and updating a plurality of identification details including but not limited to the passenger's username, user ID, the last 4 digits of the user's mobile number, at least one user profile picture, the last 4 digits of the driver's mobile number, the driver's name, booked vehicle number, a unique identification code associated with the user or vehicle or ride and any phrase selected by the user or any combination thereof in the transportation booking system 100.

The location module 204 is configured for receiving, storing, retrieving and generating a plurality of locations including but not limited to the location of the electronic device of the passenger and the location of the electronic device of the driver in the transportation booking system 100.

The display module 206 is configured for receiving, storing, retrieving and generating a plurality of identification details on an electronic display board in the transportation booking system 100.

The vehicle booking module 208 is configured for receiving, storing, retrieving and generating a plurality of vehicle booking information in the transportation booking system 100.

The ride sharing coordination module 210 is configured for receiving, storing, retrieving and updating a plurality of pickup details of exemplary passengers availing the ride sharing service in the transportation booking system 100.

The maps module 212 is configured for receiving, storing, retrieving and updating a plurality of geographical maps in the in the transportation booking system 100.

Although the pickup coordination module 110 is described as being composed of various modules, fewer or more modules (e.g. Surge Pricing Module, a Driver Settings Module) may comprise the module with the present invention still falling within the scope of various embodiments.

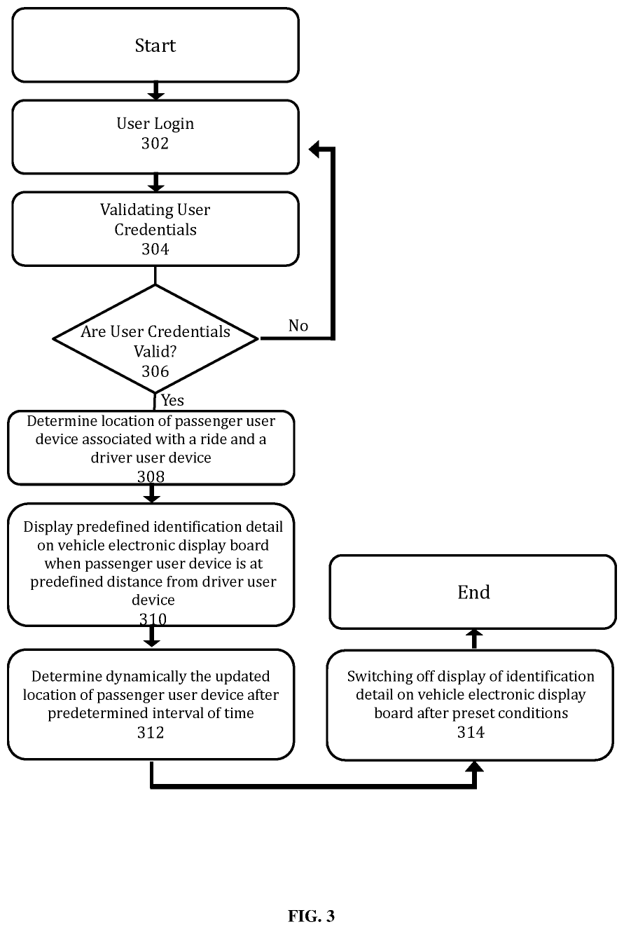

FIG. 3 is a flow diagram 300 of the method for pick-up coordination and verification of user intending to travel in a transportation booking system 100 according to one embodiment. At step 302, an exemplary user intending to travel logs into the transportation booking system using an associated electronic user device. At step 304, the user credentials of the exemplary user intending to travel are validated. At step 306, provided the user credentials are valid, the exemplary user is allowed access to the transportation booking system 100. If the user credentials are not valid, the exemplary user is denied access to the transportation booking system 100.

At step 308, the location of the exemplary passenger user device is determined via the pickup coordination module. At step 310, the predefined identification detail is display via the identification detail module, when the exemplary passenger user device is at a predefined distance from the driver user device. At step 312, the updated location of the exemplary passenger user device is dynamically determined after a predetermined interval of time. At step 314, the electronic display of identification details is turned off after preset conditions are met, the conditions including but not limited to the passenger indicating that the pickup is complete or the driver beginning the ride or after a predefined length of time has passed since the passenger location was within the predefined distance from the location of the vehicle.

Although the transportation booking system 100 is described as being composed of various components like databases and modules, the transportation booking system 100 may comprise fewer or more databases, components, and other modules. For example, the transportation booking system 100 may include a Surge Pricing Module or a Driver Settings Module with the present disclosure still falling within the scope of various embodiments. In some embodiments, an individual or group may play a plurality of user roles on the transportation booking system, with the present disclosure still falling within the scope of various embodiments.

In various embodiments the transportation booking system 100 may be any of a web application, a mobile application, or an embedded module or subsystem of a an online transportation booking environment, a mobile transportation booking environment, an electronic commerce system, an electronic payments system, a mobile operating system, a computer based operating system, or of a tablet based operating system, with the present disclosure still falling within the scope of various embodiments.

It is appreciated that, in some embodiments, various databases like 102, 104, 106, modules 110, 202, 204, 206, 208, 210, 212 as well as the databases, engines, modules and components of the above embodiments may be stored in the form of machine readable instructions in the memory of the transportation booking system 100 and executed by a processor of the transportation booking system 100 to perform one or more embodiments disclosed herein. Alternatively, the various databases like 102, 104, 106, modules 110, 202, 204, 206, 208, 210, 212 as well as the databases, engines, modules and components of the above embodiments may be implemented in the transportation booking system 100 in the form of an apparatus configured to perform one or more embodiments disclosed herein.

The online transportation booking system environment includes a transportation booking system 100 according to one embodiment. The transportation booking system 100 operates in the online transportation booking system environment and communicates with a plurality of exemplary user devices over an exemplary network. The exemplary user devices are operated by a plurality of kinds of users in the online transportation booking system environment. The exemplary user devices may comprise any of a variety of computing devices, such as a desktop computer, a laptop, a mobile device, a tablet computer, a set-top box, a kiosk, interactive television, gaming console, and other computing platforms suitable for communicating with transportation booking system 100. The transportation booking system 100 provides a system for pick-up coordination and verification of user intending to travel in a transportation system to user intending to travel in a transportation booking system. The transportation booking system 100 enables the various users to communicate and transact with other users in an online transportation booking system environment and provide services to other users. The exemplary network includes a wireless area network, a local area network, a General Packet Radio Service (GPRS) network, an Enhanced Data for Global Evolution (EDGE) network and the like. The exemplary user devices are connected to the transportation booking system 100 via an exemplary network.

Although the online transportation booking system environment is described as being composed of various, user devices (e.g., personal computer), a network (e.g., internet, intranet, world wide web), it would be appreciated by one skilled in the art that fewer or more kinds of users, user devices (e.g., a mobile phone device, a portable gaming console device, a tablet device, a learning console device, gaming console device or server device attached to a television or other screen) and networks (e.g., an intranet at hospitality service providers, restaurants, fashion products ordering platforms, FMCG, groceries and essential products ordering platforms and local travel booking platforms) may comprise the online transportation booking system environment, with the present disclosure still falling within the scope of various embodiments.

### Computing Machine Architecture

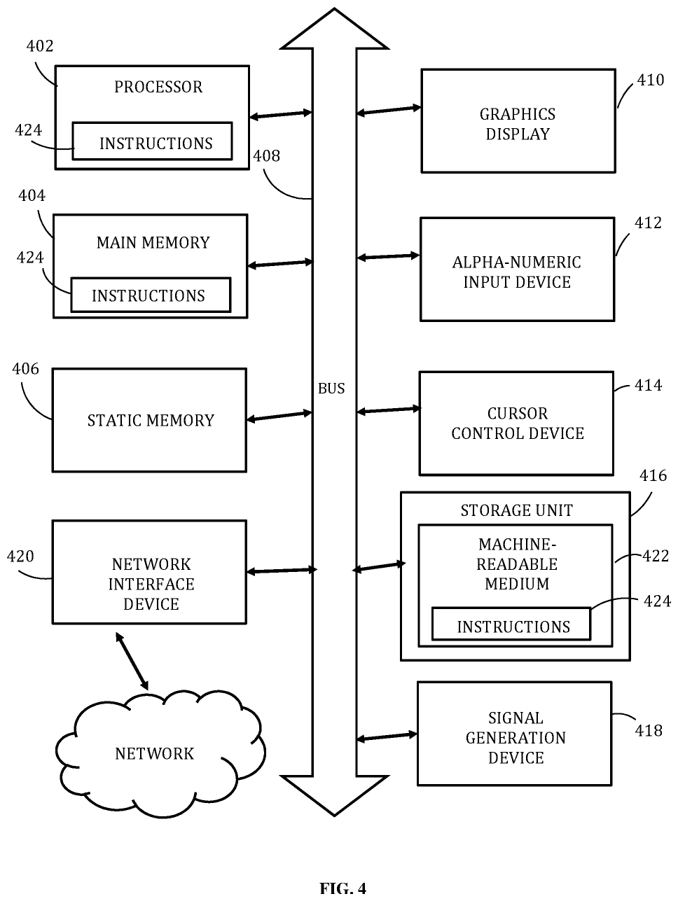

FIG. 4 is a block diagram illustrating modules of an example machine suitable for use as a transportation booking system 100, in which any of the embodiments disclosed herein may be performed, according to one embodiment. This example machine is able to read instructions from a machine-readable medium and execute them in a processor (or controller).

Specifically, FIG. 4 shows a diagrammatic representation of a machine in the example form of a computer system 400 within which instructions 424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 which carries out the computer-implemented method includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include a graphics display unit 410 (e.g., a plasma display panel (PDP), a liquid crystal display (LCD), a projector, or a cathode ray tube (CRT)). The computer system 400 may also include alphanumeric input device 412 (e.g., a keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over an exemplary network via the network interface device 420.

While machine readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

The transportation booking system 100 may be one or more servers in which one or more methods disclosed herein are performed. The processor 402 may be a microprocessor, a state machine, an application specific integrated circuit, a field programmable gate array, etc. (e.g., Intel® Pentium® processor). The main memory 404 may be a dynamic random access memory and/or a primary memory of the transportation booking system 100. The static memory 406 may be a hard drive, a flash drive, and/or other memory information associated with the transportation booking system 100.

The bus 408 may be an interconnection between various circuits and/or structures of the transportation booking system 100. The graphics display unit 410 may provide graphical representation of information on the transportation booking system 100. The alphanumeric input device 412 may be a keypad, keyboard and/or any other input device. The cursor control device 414 may be a pointing device such as a mouse.

The storage unit 416 may be a hard drive, a storage system, and/or other longer term storage subsystem. The signal generation device 418 may be a bios and/or a functional operating system of the transportation booking system 100. The network interface device 420 may be a device that may perform interface functions such as code conversion, protocol conversion and/or buffering required for communication to and from a network. The machine readable medium 422 may provide instructions 424 on which any of the methods disclosed herein may be performed. The instructions 424 may provide source code and/or data code to the processor 402 to enable any one/or more operations disclosed herein. For example, the transportation booking system 100 may be stored in the form of instructions 424 on a storage medium such as the main memory 404 and/or the machine readable medium 422 such as compact disk.

In one embodiment, a non-transitory computer-readable storage medium having tangibly embodied thereon a program of instructions executable by a processor or a computing device (e.g., the transportation booking system 100) causes the computing device to perform method steps illustrated in FIG. 3.

### Additional Configuration Considerations

Throughout this specification, plural instances may implement modules, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate modules in example configurations may be implemented as a combined structure or module. Similarly, structures and functionality presented as a single module may be implemented as separate modules. These and other variations, modifications, additions, and improvements fall within the scope of the subject matter herein.

Certain embodiments are described herein as including functionality implemented in computing logic or a number of components, modules, or mechanisms, for example, as illustrated in FIGS. 1, 2, and 3. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 402, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

In another embodiment, the pickup coordination interface provided by the transportation booking system 100 can be accessed over a local area network, intranet or virtual private network accessible to a limited plurality of user devices of hospitality service providers, restaurants, fashion products ordering platforms, FMCG, groceries and essential products ordering platforms and local travel booking platforms through a user device.

In another embodiment, pickup coordination interface provided by the transportation booking system 100 can be accessed over a wide area network, General Packet Radio Service network, an Enhanced Data for Global Evolution network, a 3G telecommunications network, a 4G LTE telecommunications network or other telecommunications network through a user device.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although the present embodiments have been described with reference to specific example embodiments, it will be evident that various modifications and changes may be made to these embodiments without departing from the broader spirit and scope of the various embodiments. For example, the various devices, modules, databases, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine modules that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and modules of the embodiments herein. This is done merely for convenience and to give a general sense of the invention. This description should be read to include one or at least one and the singular also includes the plural unless it is obvious that it is meant otherwise.

According to the embodiments described in FIG. 1 through 3, various methods and electric structures may be embodied using transistors, logic gates, and electrical circuits (e.g., Application Specific Integrated Circuitry and/or in Digital Signal Processor circuitry). For example, the pickup coordination module 110 and other modules of FIGS. 1 to 3 may be enabled using a pickup coordination circuit and other circuits using one or more of the technologies described herein. In addition, it will be appreciated that the various operations, processes, and methods disclosed herein may be embodied in a machine-readable medium and/or a machine accessible medium compatible with a data processing system (e.g., a server) and may be performed in any order. Accordingly, the specification and drawings are to be regarded in an illustrative rather than a restrictive sense.

Upon reading this disclosure, those of skill in the art will appreciate still additional alternative structural and functional designs for a system and a method for pick-up coordination and verification of user intending to travel in a transportation booking system through the disclosed principles herein. Thus, while particular embodiments and applications have been illustrated and described, it is to be understood that the disclosed embodiments are not limited to the precise construction and modules disclosed herein. Various modifications, changes and variations, which will be apparent to those, skilled in the art, may be made in the arrangement, operation and details of the method and apparatus disclosed herein without departing from the spirit and scope defined in the appended claims.

1. A method for pickup coordination of users in a transportation booking system, the system including one or more processor(s) and a plurality of electronic user devices, the plurality of electronic user devices remotely linked over a computer network through a network interface device configured to perform functions enabling communication to and from the computer network via a mobile or browser-based web application, a computer desktop application, an electronic module or subsystem of an online transportation booking environment, a travel booking environment, a hotel reservation environment, a mobile environment, an electronic commerce system, an electronic payments system, a mobile application or an Internet-based website, each of the plurality of user computing devices including an electronic user interface and an electronic display, the one or more processors configured with one or more computer-implemented modules or generators including a validation module, a pickup coordination module, an identification detail module, a location module, a display module, a vehicle booking module, a ride sharing coordination module, a maps module, a user database, a vehicle database, and a ride database, the method comprising the steps of:
determining, via the pickup coordination module, the location an electronic user device associated with at least one passenger associated with at least one driver of a vehicle, wherein the vehicle is registered with the transportation booking system;
displaying, at least one identification detail on an electronic display board associated with the vehicle, when the passenger location is within a threshold distance from the location of the vehicle;
denying, display of identification details on an electronic display board associated with the vehicle, when the passenger location is away from the threshold distance from the location of the vehicle;
dynamically determining, location of the user device associated with the passenger; and
turning off the display of the electronic display board, by the display module; wherein the identification details are no longer displayed on the electronic display board when the user has indicated that the pickup is complete or the driver begins the ride or after a predefined time elapsed since the location of the user was within the threshold distance from the location of the vehicle.

2. The method of claim 1, wherein the user pre-authorizes the display of identification details on the electronic display device associated with the vehicle.

3. The method of claim 1, wherein the identification details includes but is not limited to, the passenger's username, user ID, the last 4 digits of the user's mobile number, at least one user profile picture, the last 4 digits of the driver's mobile number, the driver's name, booked vehicle number, a unique identification code associated with the user or vehicle or ride and any phrase selected by the user or any combination thereof.

4. The method of claim 1, wherein the predefined radius is a perimeter set by the transport system to determine the vehicles available for booking within the vicinity of the user.

5. The method of claim 1, wherein the step of displaying identification details further comprises, coordinating, via the ride sharing coordination module, the successive pickup of multiple users in a transportation booking system.

6. A non-transitory computer readable storage medium having tangibly embodied thereon a program of instructions executable by a processor for pickup coordination of users in a transportation booking system, the system including one or more processors and a plurality of electronic user devices, the plurality of electronic user devices being remotely linked over a computer network through a network interface device configured to perform functions enabling communication to and from the computer network via a mobile or browser-based web application, a computer desktop application, an electronic module or subsystem of an online transportation booking environment, a travel booking environment, a hotel reservation environment, a mobile environment, an electronic commerce system, an electronic payments system, a mobile application or an Internet-based website, each of the plurality of user computing devices including an electronic user interface and an electronic display, the one or more processors configured with one or more computer-implemented modules or generators including a validation module, a pickup coordination module, an identification detail module, a location module, a display module, a vehicle booking module, a ride sharing coordination module, a maps module, a user database, a vehicle database, and a ride database, instructions when executed causing the processor to perform steps of:
determining, via the pickup coordination module, the location of an electronic user device associated with at least one passenger associated with at least one driver of a vehicle, wherein the vehicle is registered with a transportation booking system;
displaying, via the identification detail module, at least one identification detail on a display board associated with the vehicle, when the passenger location is within a predefined distance from the location of the vehicle;
denying, via the identification detail module, display of identification details on a display board associated with the vehicle, when the passenger location is away from the predefined distance from the location of the vehicle;
dynamically determining, via the location module, the location of the user device associated with the passenger; and
turning off the display of the display board, by the display module; wherein the identification details are no longer displayed on the display board when the user has indicated that the pickup is complete or the driver begins the ride or after a predefined length of time has passed since the passenger location was within the predefined distance from the location of the vehicle.

7. The non-transitory computer readable storage medium of claim 6, wherein the user pre-authorizes the display of identification details on the display device associated with the vehicle.

8. The non-transitory computer readable storage medium of claim 6, wherein the identification details includes but is not limited to, the passenger's username, user ID, the last 4 digits of the user's mobile number, at least one user profile picture, the last 4 digits of the driver's mobile number, the driver's name, booked vehicle number, a unique identification code associated with the user or vehicle or ride and any phrase selected by the user or any combination thereof.

9. The non-transitory computer readable storage medium of claim 6, wherein the predefined radius is a perimeter set by the transport system to determine the vehicles available for booking within the vicinity of the user.

10. The non-transitory computer readable storage medium of claim 6, wherein the step of displaying identification details executed by instructions further comprises, coordinating, via the ride sharing coordination module, the successive pickup of multiple users in a transportation booking system.

11. An apparatus comprising:
a network interface configured for pickup coordination of users in a transportation booking system,
a processor coupled to the network interface,
a memory coupled to the processor, wherein the memory comprises instructions for execution on the processor to perform steps of:
determining, via the pickup coordination module, the location of an electronic user device associated with at least one passenger associated with at least one driver of a vehicle, wherein the vehicle is registered with a transportation booking system;
displaying, via the identification detail module, at least one identification detail on a display board associated with the vehicle, when the passenger location is within a predefined distance from the location of the vehicle;
denying, via the identification detail module, display of identification details on a display board associated with the vehicle, when the passenger location is away from the predefined distance from the location of the vehicle;
dynamically determining, via the location module, the location of the user device associated with the passenger; and
turning off the display of the display board, by the display module; wherein the identification details are no longer displayed on the display board when the user has indicated that the pickup is complete or the driver begins the ride or after a predefined length of time has passed since the passenger location was within the predefined distance from the location of the vehicle.

12. The apparatus of claim 11, wherein the user pre-authorizes the display of identification details on the display device associated with the vehicle.

13. The apparatus of claim 11, wherein the identification details includes but is not limited to, the passenger's username, user ID, the last 4 digits of the user's mobile number, at least one user profile picture, the last 4 digits of the driver's mobile number, the driver's name, booked vehicle number, a unique identification code associated with the user or vehicle or ride and any phrase selected by the user or any combination thereof.

14. The apparatus of claim 11, wherein the predefined radius is a perimeter set by the transport system to determine the vehicles available for booking within the vicinity of the user.

15. The apparatus of claim 11, wherein the step of displaying identification details executed by instructions further comprises, coordinating, via the ride sharing coordination module, the successive pickup of multiple users in a transportation booking system.
